(19) United States
(12) Patent Application Publication
(10) Pub. No.: US 2018/0257997 A1
(43) Pub. Date: Sep. 13, 2018

(54) RESIDUAL STRESS FREE JOINED SILICON CARBIDE CERAMICS AND PROCESSING METHOD OF THE SAME

(71) Applicant: University of Seoul Industry Cooperation Foundation, Seoul (KR)

(72) Inventors: Young Wook KIM, Seoul (KR); Seung Hoon JANG, Yangju-si (KR)

(73) Assignee: University of Seoul Industry Cooperation Foundation, Seoul (KR)

(21) Appl. No.: 15/879,376

(22) Filed: Jan. 24, 2018

(30) Foreign Application Priority Data
Mar. 10, 2017 (KR) 10-2017-0030548

(51) Int. Cl. C04B 37/00; C04B 35/565; C04B 35/64

(52) U.S. Cl. CPC C04B 37/001; C04B 35/565; C04B 35/64; C04B 2235/963; C04B 2235/602; C04B 2235/6567; C04B 2235/6581; C04B 2235/3826

(57) ABSTRACT

The present invention relates to joined silicon carbide (SiC) ceramics and a method for processing the same. And, most particularly, the joined silicon carbide (SiC) ceramics and the method for processing the same provide a method for processing joined silicon carbide (SiC) ceramics including the steps of sintering silicon carbide substrates configuring the joined ceramics, processing a joined silicon carbide ceramics preparation by layering a non-sintered silicon carbide bond having a same composition as the silicon carbide substrate between at least two substrates selected from the sintered silicon carbide substrates, and processing the joined silicon carbide ceramics by performing heat treatment on the joined silicon carbide ceramics preparation. According to the above-described invention, by using a bond having the same composition as the silicon carbide substrate, since residual stress-free joined ceramics can be processed, joined silicon carbide ceramics having a high strength corresponding to 65 to 190% of a strength of the substrate may be processed.

This application claims the benefit of the Korean Patent Application No. 10-2017-0030548, filed on Mar. 10, 2017, which is hereby incorporated by reference as if fully set forth herein.

### BACKGROUND OF THE INVENTION

### Field of the Invention

The present invention relates to residual stress-free joined silicon carbide (SiC) ceramics and a processing method of the same. And, most particularly, the present invention provides a method for processing joined silicon carbide (SiC) ceramics including the steps of sintering silicon carbide substrates configuring joined ceramics, processing a joined SiC ceramics preparation by layering a SiC bond having the same composition as the SiC substrate between at least two SiC substrates selected from the sintered SiC substrates, and processing joined SiC ceramics by performing heat treatment on the joined SiC ceramics preparation.

The present invention also provides a method for processing joined SiC ceramics including the steps of processing SiC substrates as sintering bodies by using a liquid-phase sintering method, and joining two SiC substrates without any bond.

### Discussion of the Related Art

Silicon carbide (SiC) has excellent wear resistance, oxidation resistance, and high-temperature strength and also has excellent hardness and thermal conductivity, and, therefore, SiC is used in high-temperature structural materials, heat exchangers, and micro gas turbines, and so on. Most particularly, in case SiC is processed as joined ceramics (or joint), this may be more broadly applied as a means of reinforcement, supplementation, and replacement in vulnerable or essential areas of the mechanical properties. And, silicon carbide (SiC) is also a promising material that can be applied to the processing of complex shapes that cannot be processed with a single-type ceramic and to the fabrication of large-sized devices.

Most particularly, since the joined SiC ceramics are stable in high temperature conditions of 1200° C. or higher, they contribute significantly in enhancing the quality and efficiency of a semiconductor diffusion process and a chemical vapor deposition (CVD) process. A detailed application example corresponds to a wafer boat that is used in the semiconductor processes. Moreover, since the heat exchanger, the micro gas turbine, the cladding tube of a nuclear fuel rod, the blanket of a high temperature fusion reactor, and so on, have complex shapes or an internal path (or tunnel), such parts cannot be fabricated with a single type ceramic, once the joined ceramics are processed by performing the bonding (or joining) process, the fabrication of a 3-dimensional complex structure may be easily carried out. Thus, the joined silicon carbide ceramics may be widely used in heat exchangers, micro gas turbines, cladding tubes of nuclear fuel rods, blankets of high temperature fusion reactors, and so on.

Depending upon the composition of the joined ceramics (or joint), the technology for processing joined silicon carbide (SiC) ceramics is known to include solid state diffusion bonding, metallic brazing bonding, Si-C reaction bonding, Polymer-derived ceramics joining, and so on.

The above-described method for processing joined SIC ceramics includes a method using joined ceramics including soft metal, which is disclosed in the Korean Patent Application No. 10-0709544, a method of using a Six-Ge(1-x) solid solution as a bond, which is disclosed in the Korean Patent Application No. 10-1054863, a method of using a ceramic polymer or aluminum foil, which is disclosed in the Korean Patent Application No. 10-2013-0090788, and so on. The strength of the joined silicon carbide (SiC) ceramics, which are processed as described above, corresponds to a 25˜90% of the strength of a silicon carbide substrate, which corresponds to a lower bending strength than a parent material. This is because a silicon carbide substrate and joined ceramics consisting of another composition have been used. And, this is also because residual stress inevitably remains at the bonding part (or joining part) due to a difference in the coefficient of thermal expansion between the joined ceramics and the silicon carbide.

Additionally, some of the joined ceramics using the metal brazing technology are disadvantageous in that they may be easily oxidized in an oxidation environment, most particularly, at a high temperature. In case of the joined silicon carbide (SiC) ceramics that are joined by using the metal brazing method, when being used in an oxidation environment and at a high temperature, the oxidation tends to weaken the bonding part and reduce the durability of the joined silicon carbide ceramics.

Therefore, although diverse methods for processing joined silicon carbide ceramics exist, in order to fabricate (or process) joined ceramics having a strength equivalent to the strength of a silicon carbide substrate, a method for processing residual stress-free joined silicon carbide ceramics that can be used in an oxidation and high-temperature environment is proposed herein. This method corresponds to a novel technology that has never been reported and that may act as an improvement in the technical field.

### SUMMARY OF THE INVENTION

Accordingly, the present invention is directed to residual stress-free joined silicon carbide (SiC) ceramics and a processing method of the same that substantially obviate one or more problems due to limitations and disadvantages of the related art.

A technical object of the present invention is to provide a method for processing joined SiC ceramics that can ensure stability when operated at a high temperature, since residual stress does not exist at the bonding part (or joining part) because the substrate and the bond have the same composition, and since the strength of the bonding part is equal to or greater than the strength of the substrate, thereby allowing the joined SiC ceramics to be highly resistant to oxidation.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, according to an exemplary embodiment of the present invention, provided herein is a method for processing joined silicon carbide (SiC) ceramics including the steps of sintering silicon carbide substrates configuring the joined ceramics, processing a joined silicon carbide ceramics preparation by layering a non-sintered silicon carbide bond having a same composition as the silicon carbide substrate between at least two substrates selected from the sintered silicon carbide substrates, and processing the joined silicon carbide ceramics by performing heat treatment on the joined silicon carbide ceramics preparation.

Preferably, the silicon carbide bond may correspond to one of a silicon carbide sheet green body, silicon carbide powder, and silicon carbide slurry.

Preferably, the silicon carbide slurry may be formed by being deposited or sprayed on a silicon carbide substrate.

Preferably, in the step of processing a joined silicon carbide ceramics preparation, the joined silicon carbide ceramics preparation may be processed with calcination in order to scatter organic matter remaining on the silicon carbide sheet.

Preferably, the calcination process may be performed within a temperature range of 850˜900° C. during a time period of 30 minutes to 2 hours.

Preferably, in the step of processing the joined silicon carbide ceramics, a processing atmosphere may be identical to an atmosphere for the sintering of the silicon carbide substrate, and wherein the processing is performed at a temperature at which a sintering additive forms liquid.

Preferably, hot press may be performed when performing sintering, the processing atmosphere may correspond to one of argon, nitrogen, or vacuum, and the heat treatment temperature may range from 1750° C. to 2000° C.

Preferably, in the step of sintering silicon carbide substrates, silicon carbide powder may be mixed with a sintering additive, molded, and sintered at a temperature ranging from 1750° C. to 2100° C.

Additionally, provided herein is a method for processing joined silicon carbide (SiC) ceramics including the steps of sintering silicon carbide substrates configuring the joined ceramics, applying roughness to a surface of the silicon carbide substrate, and contacting at least two silicon carbide substrates selected from the silicon carbide substrates having roughness applied thereto and bonding the at least two silicon carbide substrates with liquid at a liquid-forming temperature.

Furthermore, the present invention is processed according to the above-described method, wherein residual stress does not exist throughout the entire joined ceramics, and wherein a strength of a bonding part may correspond to 65 to 190% of a strength of the substrate.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a microscopic photo of a residual stress-free fine structure between a substrate of joined ceramics and a bond, wherein the joined ceramics are processed by using the method of processing joined SiC ceramics according to an exemplary embodiment of the present invention.

FIG. 2 is a microscopic photo of a residual stress-free fine structure between a substrate of a bonding part (or joining part), which is bonded (or joined) with pressure at a pressure of 10 MPa and at a temperature of 1800° C. by using a silicon carbide tape (SiC tape) as the bond, which is identical to the substrate, during the method for processing joined SiC ceramics according to the exemplary embodiment of the present invention. The dotted line indicates a boundary surface (or interface) between the substrate and the bonding part.

FIG. 3 is a microscopic photo of a residual stress-free fine structure between a substrate of a bonding part, which is bonded with pressure at a pressure of 10 MPa and at a temperature of 1850° C. by using a silicon carbide tape (SiC tape) as the bond, which is identical to the substrate, during the method for processing joined SiC ceramics according to the exemplary embodiment of the present invention. The dotted line indicates a boundary surface (or interface) between the substrate and the bonding part.

FIG. 4 is a microscopic photo of a residual stress-free fine structure between a substrate of a bonding part, which is bonded with pressure at a pressure of 10 MPa and at a temperature of 1900° C. by using a silicon carbide tape (SiC tape) as the bond, during the method for processing joined SiC ceramics according to the exemplary embodiment of the present invention. The dotted line indicates a boundary surface (or interface) between the substrate and the bonding part.

FIG. 5 is a microscopic photo of a residual stress-free fine structure between a substrate of a bonding part, which is bonded with pressure at a pressure of 20 MPa and at a temperature of 1850° C. by using a silicon carbide tape (SiC tape) as the bond, during the method for processing joined SiC ceramics according to the exemplary embodiment of the present invention. The dotted line indicates a boundary surface (or interface) between the substrate and the bonding part.

FIG. 6 is a microscopic photo of a residual stress-free fine structure between a substrate of a bonding part, which is bonded with pressure at a pressure of 10 MPa and at a temperature of 1850° C. without applying any bond, during the method for processing joined SiC ceramics according to the exemplary embodiment of the present invention. The white arrow indicates a boundary between the bonding part and the substrate.

FIG. 7 is a microscopic photo of a residual stress-free fine structure between a substrate of a bonding part, which is bonded with pressure at a pressure of 15 MPa and at a temperature of 1850° C. without applying any bond, during the method for processing joined SiC ceramics according to the exemplary embodiment of the present invention. The white arrow indicates a boundary between the bonding part and the substrate.

FIG. 8 is a microscopic photo of a residual stress-free fine structure between a substrate of a bonding part, which is bonded with pressure at a pressure of 20 MPa and at a temperature of 1850° C. without applying any bond, during the method for processing joined SiC ceramics according to the exemplary embodiment of the present invention.

### DETAILED DESCRIPTION OF THE INVENTION

Hereinafter, the exemplary embodiments of the present invention will be illustrated in the appended drawings and described in detail in the detailed description of the present invention. In describing the present invention, when it is determined that the detailed description on a related disclosed technology may cause ambiguity in the concept (or idea) of the present invention, the detailed description of the same will be omitted for simplicity.

The terms used in the description of the present invention are defined based on their corresponding functions within the present invention. And, since the meaning of such terms may vary in accordance with the intentions or practices of anyone skilled in the art, the definition of the terms used in the description of the present invention should be understood based on the overall context of this specification.

The terms used in this specification are merely given and used to describe specific exemplary embodiments of the present invention. And, therefore, the terms used herein are not intended to limit the present invention. Unless specified otherwise, singular forms include the respective plural forms. In this specification, the terms “include(s)” or “has/have”, and so on are used to designate and/or indicate the presence of an embodied characteristic, number, step, operation, configuration element, assembly part, or a combination of two or more of the same. Therefore, it should be understood that the presence or additional possibilities of one or more of other characteristics, numbers, steps, operations, configuration elements, assembly parts, or combinations of two or more of the same will not be excluded in advance.

Hereinafter, the present invention will be described in detail.

The method for processing joined SiC ceramics according to the present invention may include the steps of processing a sintering pellet by sintering silicon carbide substrates configuring joined ceramics, applying a bond on at least one bonding surface, among bonding surfaces of at least two silicon carbide substrates being selected from the processed silicon carbide sintering pellet, or layering a bond between the silicon carbide substrates, and performing sintering so as to bond to two silicon carbide substrates.

The silicon carbide substrate shows excellent characteristics of wear resistance, corrosion resistance, high thermal conductivity, chemical stability, and so on, and, then, it is preferable to mix silicon carbide powder with a sintering additive, to perform molding, and then to perform sintering at a temperature ranging from 1750° C. to 2100° C.

Meanwhile, although a particle size of silicon carbide that is being used for processing the silicon carbide substrate is not particularly limited, in order to reduce the content of the sintering additive, which causes enhanced sintering characteristics and increased volume resistivity in accordance with a high specific surface area, it is preferable that the silicon carbide particle has a fineness number of a micron or sub-micron.

Additionally, although the composition of the sintering additive is not particularly limited, it is preferable to use a sintering additive that can enhance the sintering characteristics.

In the step of applying a bond on at least one bonding surface, among bonding surfaces of at least two silicon carbide substrates, or layering a bond between the silicon carbide substrates, a bond having the same composition as the silicon carbide substrate is used. As long as the composition is identical, although the form of the bond is not particularly limited, in order to facilitate the adjustment of the thickness of the bond, which may influence the mechanical properties of the joined ceramics, it is preferable to use a tape (sheet) being fabricated by using a tape casting method, powder, a slurry consisting of a mixture of powder and a solvent, or a spray. More specifically, if the bond corresponds to a tape, the tape is layered between the silicon carbide substrates, the powder is diffused or deposited on any one surface of the silicon carbide substrates, and the slurry is deposited on any one surface of the silicon carbide substrates. For the spray type, a spraying device may be used.

Furthermore, when preparing the bond, diverse powder milling methods may be used. For example, in order to prepare a slurry, mixed powder may be mixed to an organic solvent, such as ethanol, and may then be diffused, or a planetary milling method using a ball to perform milling may be used. However, the bond may be prepared by using diverse methods without being limited only to the above-described methods.

Additionally, a method of bonding the bonding surfaces of two silicon carbide substrates without applying any bond may also be included herein. This is because the bonding part of the joined ceramics has the same composition as the two silicon carbide substrates. As described above, by using the same composition for the bond and the bonding substrate, joined ceramics having no residual stress or fine cracks may be processed. Thus, joined silicon carbide ceramics having significantly enhanced mechanical properties may be processed.

In the step of bonding two silicon carbide substrates, it is preferable that a bonding atmosphere has the same condition as the sintering condition of the two silicon carbide substrates. More specifically, if the silicon carbide substrates are sintered in an argon atmosphere, it is preferable that the bonding step is also carried out in an argon atmosphere. Since the type of liquid being formed by the sintering mechanism of silicon carbide may become different in accordance with the sintering atmosphere, if sintering is carried out in different atmospheres, it may become difficult to match the compositions and structures of the substrates and the bond. Therefore, it is preferable to perform bonding in a condition that is identical to the sintering condition.

Additionally, when performing the bonding process, although it is preferable that the bonding temperature is set to the sintering temperature of the silicon carbide substrate, which ranges from 1750° C. to 2000° C., the present invention will not be limited only to this. Herein, the range of the bonding temperature will not be limited, as long as the bonding temperature is within a temperature range that forms liquid in both the substrates and the bond.

In case the bond and the substrates are formed to have the same composition, the mechanism of bonding the two substrates corresponds to forming a liquid by using the additive of the bond, and by having a liquid having the same composition formed from the substrate at the same time, the bonding occurs due to the bonding force of the formed liquid.

In case a bond is not applied, the mechanism of bonding the two substrates is as follows. In case of the liquid-phase sintering of silicon carbide, the liquid that existed at a high temperature changes to a solid form during the process of completing the sintering process and being cooled. Once the silicon carbide is re-heated for the bonding process, the liquid is once again formed in the substrate, and by properly contacting the two substrates in order to bind them together, air holes are formed between the contacting surface of the two substrates due to a surface roughness of the silicon carbide substrates. Thereafter, as the capillary force of the air holes pulls the liquid formed within the substrates, the pulled liquid fills the air holes so as to form a bonding layer. Accordingly, the liquid acts as a bond, thereby bonding the two substrates.

Hereinafter, exemplary embodiments of the present invention will be described in more detail.

The exemplary embodiments presented below are merely exemplary and, therefore, will not limit the scope of the present invention.

### Processing Embodiment

[Processing of a Silicon Carbide Substrate]

The two silicon carbide substrates configuring the joined silicon carbide ceramics used commercially available sub-micron β-SiC powder (Grade BF-17, H.C. Starck, Berlin, Germany), commercially available sub-micron α-SiC powder (FCP15C, Norton AS, Lillesand, Norway), Al₂O₃ powder (AKP-30, Sumitomo Chemical Co., Tokyo, Japan), Y₂O₃ powder (Kojundo Chemical Laboratory Co., Ltd.), and MgO powder (Kojundo Chemical Laboratory Co., Ltd.) as the starting materials.

By using a SiC ball and a polypropylene container, the mixed powder arrangement shown below in Table 1 is mixed in ethanol for 24 hours. As shown below in Table 1, a total content of additives in the arrangement is fixed to 4 wt %.

TABLE 1

| | Composition of | | Thickness | 4-point bending | | |
|---|---|---|---|---|---|---|
| | Silicon Carbide | Composition | of bonding | strength (MPa) | | |
| | substrate | of bond | layer | Joined | Parent | Crack |
| No. | (wt %) | (wt %) | (μm) | ceramics | material | location |
| 1 | 1.000% α-SiC + | Same | ~40 | 196 | 289 | Bonding |
| | 95.000% β-SiC + | composition | | | | interface |
| | 2.560% Al₂O₃ + | as substrate | | | | |
| | 1.040% Y₂O₃ + | | | | | |
| | 0.400% MgO | | | | | |
| 2 | | Same | ~40 | 295 | 289 | Inside parent |
| | | composition | | | | material |
| | | as substrate | | | | |
| 3 | | Same | ~40 | 332 | 289 | Bonding |
| | | composition | | | | interface and |
| | | as substrate | | | | inside parent |
| | | | | | | material |
| 4 | | Same | ~35 | 343 | 289 | Inside parent |
| | | composition | | | | material |
| | | as substrate | | | | |
| 5 | | None | ~1.5 | 401 | 289 | Inside parent |
| | | | | | | material |
| 6 | | None | ~1.5 | 464 | 289 | Inside parent |
| | | | | | | material |
| 7 | | None | ~1.5 | 550 | 289 | Inside parent |
| | | | | | | material |

After drying the slurry that has been processed in the mixing process, sieving is performed by using a 60 mesh sieve, and, then, sintering is performed by using a hot press sintering method at a pressure of 20 MPa for 6 hours under an argon atmosphere of 1800° C. The sintered silicon carbide bulk material is then cut to 2 pieces of 15 mm×15 mm×12.5 mm, and the bonding surface is polished to ˜1 μm.

### Embodiment 1

Among the bonding surfaces, one surface is formed of a silicon carbide tape, and a bond having the same composition as the substrate is applied with a thickness of ˜180 μm. Subsequently, after applying a uniaxial pressure on both substrates, heat treatment (calcination) is performed for 1 hour at a temperature of 900° C. in an argon atmosphere. This is to remove a binder of the tape-type bond in advance so as to control the air holes that may be formed at the bonding part of the joined ceramics. Herein, the temperature and time may be varied. And, preferably, the process may be managed within a temperature range from 850 to 950 t and a time period of 30 minutes to 2 hours.

The heat-treated joined silicon carbide ceramics are processed with a hot press heat-treatment in a hot press heating device. At this point, the pressure of the hot press device is 10 MPa, and the temperature of the heat treatment is 1800° C. The heat treatment is carried out for 1 hour, and argon gas is used for the heat-treatment atmosphere.

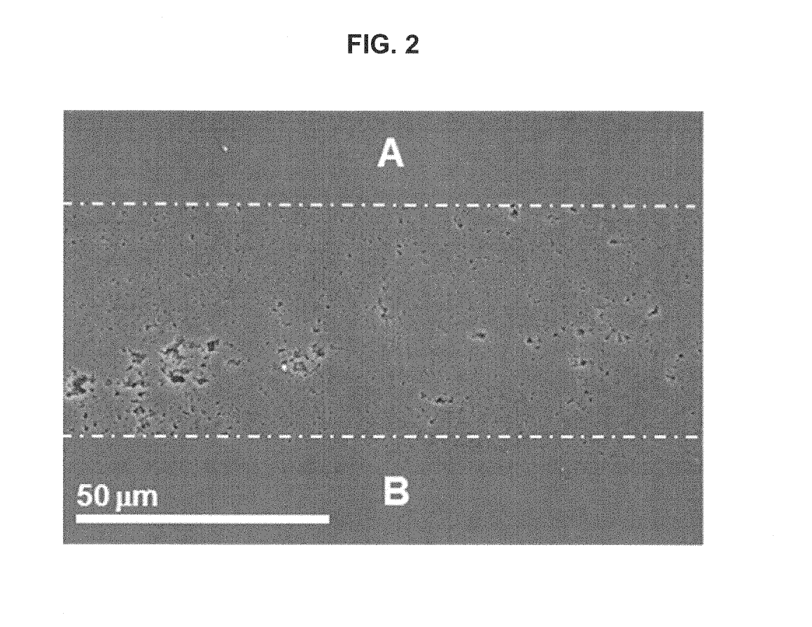

FIG. 2 is a microscopic photo taken by a scanning electron microscope of a cross-section of joined silicon carbide ceramics after being processed with the hot press heat treatment. From the scanning electron microscope, it can be seen that the joined ceramics part (dotted line) is clearly differentiated from the two silicon carbide substrates (A, B) due to the larger number of air holes formed thereon. However, since its composition is identical to that of the substrates, residual stress does not exist.

The joined ceramics are cut to a stick-type sample having a size of 2 mm×1.5 mm×25 mm according to the standard size of ASTM C 1161-13 and then polished. A tensile surface of the stick is polished with a 1-μm diamond paste. And, in order to avoid a large edge defect and accumulation of stress caused by the sectioning, the edge part is formed to have a round shape. The bending strength test is carried out by using a 4-point being strength measurement, wherein the internal span and the external span are respectively equal to 10 mm and 20 mm at a cross-head speed of 0.2 mm/min.

The 4-point bending strength test results are shown in Table 1. It can be seen that Joined ceramics No. 1, which corresponds to the first embodiment, has no external defects, and that the thickness of the bonding layer is formed to be equal to approximately ˜40 μm. Also, test pieces are fabricated only for the substrate, and the 4-point bending strength is compared with that of the joined ceramics. For Joined ceramics No. 1, all test pieces are destroyed (or cracked) at the bonding interface, and the bending strength is equal to 196 MPa, which corresponds to more than 65% of the 4-point bending strength of the parent material (289 MPa).

### Embodiment 2

Among the bonding surfaces, one surface is formed of a silicon carbide tape, and a bond having the same composition as the substrate is applied with a thickness of ˜180 μm. Subsequently, after applying a uniaxial pressure on both substrates, heat treatment is performed for 1 hour at a temperature of 900° C. in an argon atmosphere. This is to remove a binder of the tape-type bond in advance so as to control the air holes that may be formed at the bonding part of the joined ceramics.

The heat-treated joined silicon carbide ceramics are processed with hot press heat-treatment in a hot press heating device. At this point, the pressure of the hot press device is 10 MPa, and the temperature of the heat treatment is 1850° C. The heat treatment is carried out for 1 hour, and argon gas is used for the heat-treatment atmosphere.

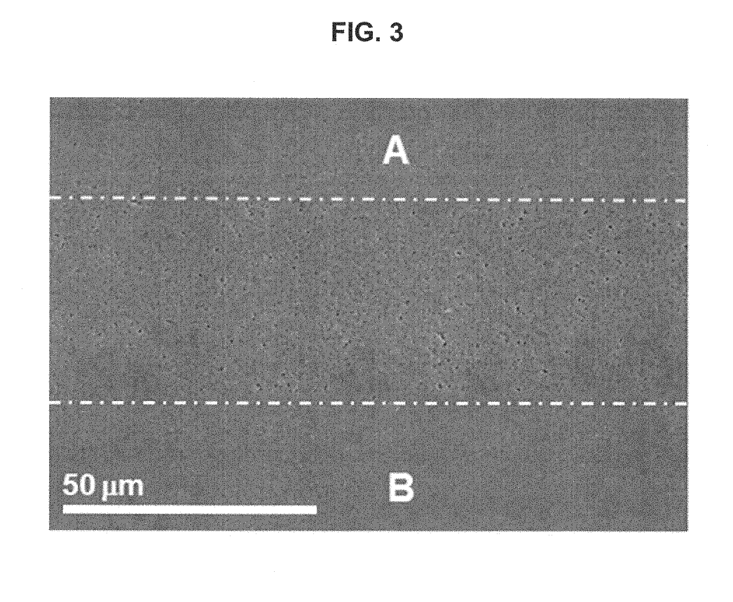

FIG. 3 is a microscopic photo taken by a scanning electron microscope of a cross-section of joined silicon carbide ceramics after being processed with the hot press heat treatment. From the scanning electron microscope, it can be seen that the bonding result is good, since the two silicon carbide substrates (A, B) and the joined ceramics part (dotted line) cannot be differentiated from one another.

Bending strength test pieces having the size of 2 mm×1.5 mm×25 mm are prepared by using the same method as the first embodiment, and the 4-point bending strength is measured by using the same method as the first embodiment.

The 4-point bending strength test results are shown in Table 1, wherein comparison is made with the bending strength of the substrate. It can be seen that Joined ceramics No. 2, which corresponds to the second embodiment, has no external defects, and that the thickness of the bonding layer is formed to be equal to approximately ˜40 μm. Also, for Joined ceramics No. 2, all test pieces are destroyed (or cracked) at inside the parent material, and the 4-point bending strength is equal to 295 MPa, which is almost equivalent to the bending strength of the silicon carbide substrate.

### Embodiment 3

Among the bonding surfaces, one surface is formed of a silicon carbide tape, and a bond having the same composition as the substrate is applied with a thickness of ˜180 μm. Subsequently, after applying a uniaxial pressure on both substrates, heat treatment is performed for 1 hour at a temperature of 900° C. in an argon atmosphere. This is to remove a binder of the tape-type bond in advance so as to control the air holes that may be formed at the bonding part of the joined ceramics.

The heat-treated joined silicon carbide ceramics are processed with hot press heat-treatment in a hot press heating device. At this point, the pressure of the hot press device is 10 MPa, and the temperature of the heat treatment is 1900° C. The heat treatment is carried out for 1 hour, and argon gas is used for the heat-treatment atmosphere.

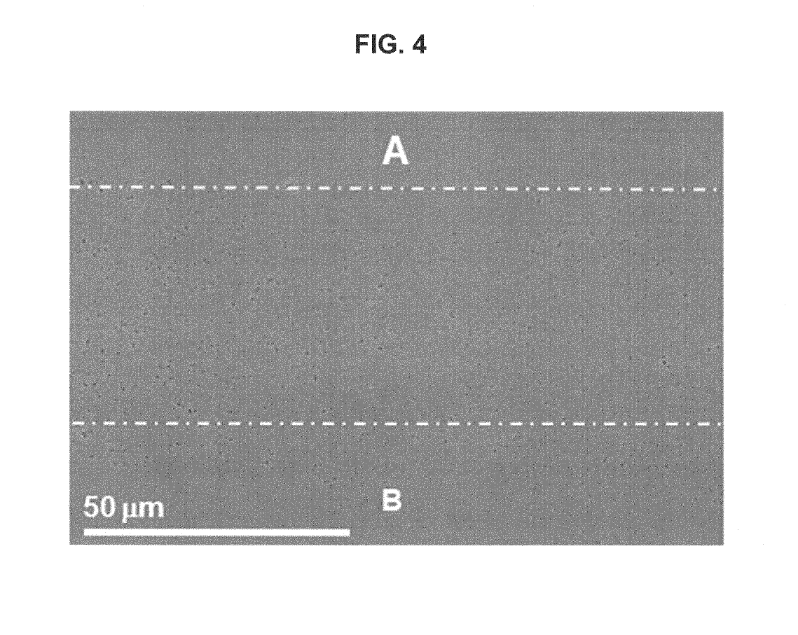

FIG. 4 is a microscopic photo taken by a scanning electron microscope of a cross-section of joined silicon carbide ceramics after being processed with the hot press heat treatment. From the scanning electron microscope, it can be seen that the bonding result is good, since the two silicon carbide substrates (A, B) and the joined ceramics part (dotted line) cannot be differentiated from one another.

Bending strength test pieces having the size of 2 mm×1.5 mm×25 mm are prepared by using the same method as the first embodiment, and the bending strength is measured by using the same 4-point bending strength measurement as the first embodiment.

The 4-point bending strength test results are shown in Table 1, wherein comparison is made with the bending strength of the substrate. It can be seen that Joined ceramics No. 3, which corresponds to the third embodiment, has no external defects, and that the thickness of the bonding layer is formed to be equal to approximately ˜40 μm. For Joined ceramics No. 3, all test pieces are destroyed (or cracked) at inside the parent material or at the bonding interface, and the 4-point bending strength is equal to 332 MPa, which indicates that the bending strength has increased to approximately 15% as compared to the unique strength of the silicon carbide substrate.

### Embodiment 4

Among the bonding surfaces, one surface is formed of a tape, and a bond having the same composition as the substrate is applied with a thickness of ˜180 μm. Subsequently, after applying a uniaxial pressure on both substrates, heat treatment is performed for 1 hour at a temperature of 900° C. in an argon atmosphere. This is to remove a binder of the tape-type bond in advance so as to control the air holes that may be formed at the bonding part of the joined ceramics.

The heat-treated joined silicon carbide ceramics are processed with hot press heat-treatment in a hot press heating device. At this point, the pressure of the hot press device is 20 MPa, and the temperature of the heat treatment is 1850° C. The heat treatment is carried out for 1 hour, and argon gas is used for the heat-treatment atmosphere. The hot press heat treatment is carried out at a higher pressure condition as compared to the first to third embodiments.

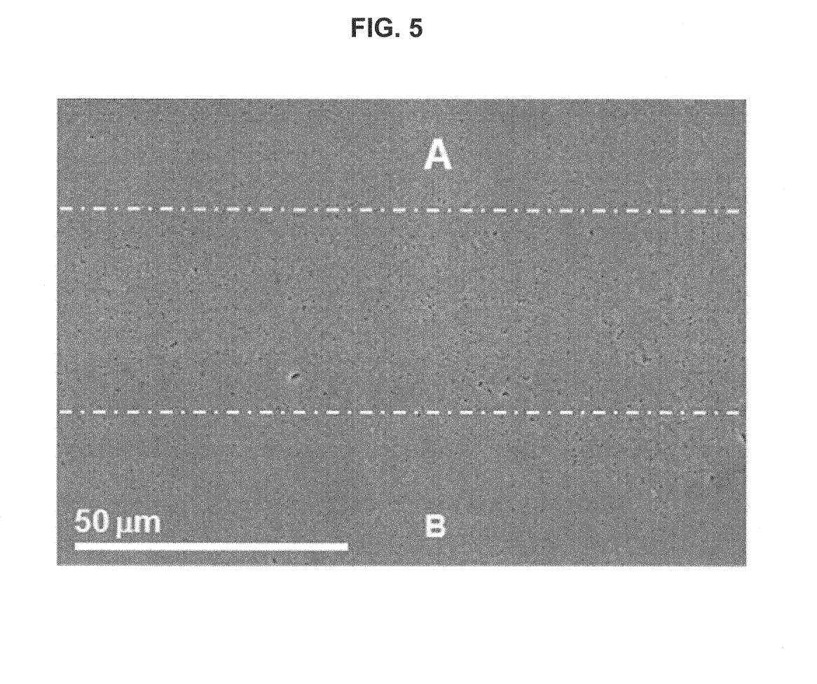

FIG. 5 is a microscopic photo taken by a scanning electron microscope of a cross-section of joined silicon carbide ceramics after being processed with the hot press heat treatment. From the scanning electron microscope, it can be seen that the bonding result is good, since the two silicon carbide substrates (A, B) and the joined ceramics part (dotted line) cannot be differentiated from one another.

Bending strength test pieces having the size of 2 mm×1.5 mm×25 mm are prepared from the joined ceramics by using the same method as the first embodiment, and the 4-point bending strength is measured by using the same method as the first embodiment.

The 4-point bending strength test results are shown in Table 1, wherein comparison is made with the bending strength of the substrate. It can be seen that Joined ceramics No. 4, which corresponds to the fourth embodiment, has no external defects, and that the thickness of the bonding layer is formed to be equal to approximately ˜35 μm. The thickness of the bonding layer is thinner than the first embodiment to the third embodiment because the pressure applied during the bonding process has increased to 20 MPa, which is greater than the pressure used in the first embodiment to the third embodiment.

For Joined ceramics No. 4, all test pieces are destroyed (or cracked) at inside the parent material, and the 4-point bending strength is equal to 343 MPa, which indicates that the bending strength has increased to approximately 19% as compared to the unique strength of the silicon carbide substrate.

### Embodiment 5

In order to create a bonding part having the same composition as the substrates, nothing is added to the bond, and, after aligning the two substrates in the form of sticks, the joined silicon carbide ceramics are processed with hot press heat treatment in a hot press heating device. At this point, the pressure of the hot press device is equal to 10 MPa, and the temperature of the heat treatment is 1850° C. The heat treatment is carried out for 1 hour, and argon gas is used for the heat-treatment atmosphere.

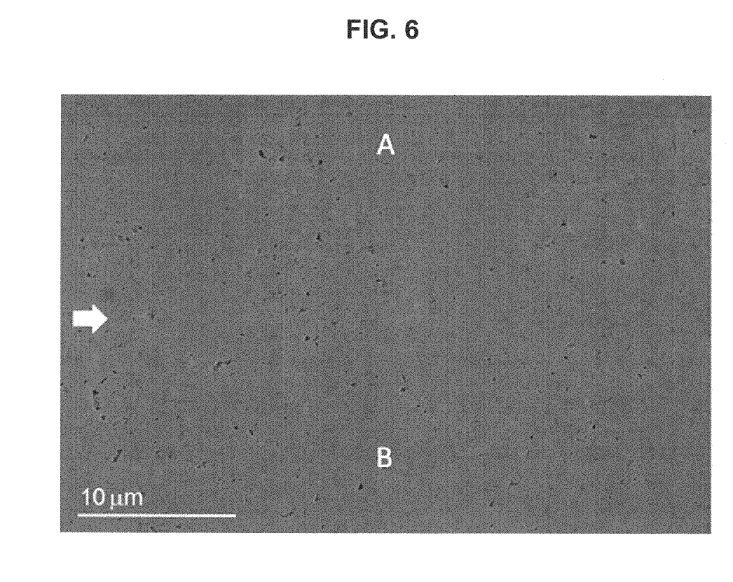

FIG. 6 is a microscopic photo taken by a scanning electron microscope of a cross-section of joined silicon carbide ceramics after being processed with the hot press heat treatment. It can be seen that the bonding result is good, since the two silicon carbide substrates (A, B) and the bonding part (arrow) cannot be differentiated from one another.

Bending strength test pieces having the size of 2 mm×1.5 mm×25 mm are prepared from the joined ceramics by using the same method as the first embodiment, and the 4-point bending strength is measured by using the same method as the first embodiment.

The 4-point bending strength test results are shown in Table 1, wherein comparison is made with the bending strength of the substrate. It can be seen that Joined ceramics No. 5, which corresponds to the fifth embodiment, has no external defects, and that the thickness of the bonding layer is formed to be equal to approximately 1.5 μm. For Joined ceramics No. 5, all test pieces are destroyed (or cracked) at inside the parent material, and the 4-point bending strength is equal to 401 MPa, which indicates that the bending strength is enhanced to approximately 39% as compared to the unique strength of the silicon carbide substrate.

### Embodiment 6

In order to create a bonding part having the same composition as the substrates, nothing is added to the bond, and, after aligning the two substrates in the form of sticks, the joined silicon carbide ceramics are processed with hot press heat treatment in a hot press heating device. At this point, the pressure of the hot press device is equal to 15 MPa, and the temperature of the heat treatment is 1850° C. The heat treatment is carried out for 1 hour, and argon gas is used for the heat-treatment atmosphere. Additionally, when required, after performing the sintering process, roughness may be added to the surface of the silicon carbide substrate. The advantages of the case where roughness is added has already been described above.

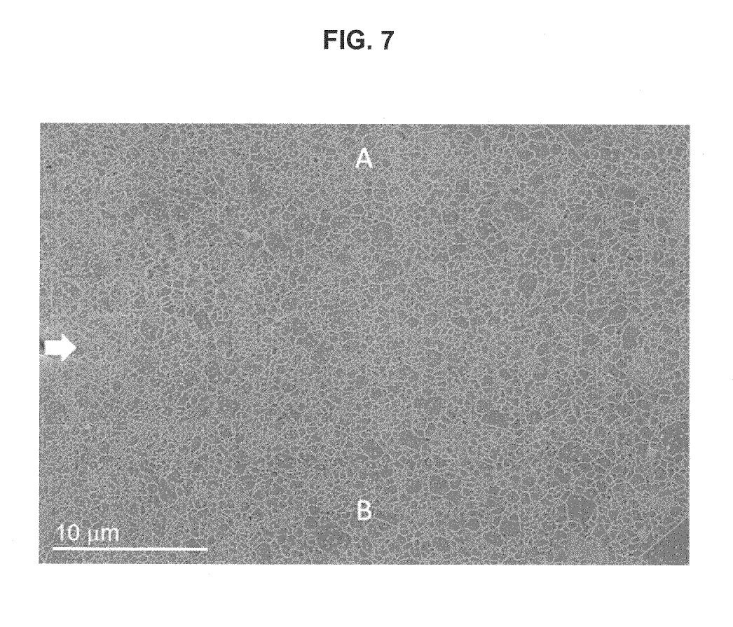

FIG. 7 is a microscopic photo taken by a scanning electron microscope of a cross-section of joined silicon carbide ceramics after being processed with the hot press heat treatment. It can be seen that the bonding result is good, since the two silicon carbide substrates (A, B) and the bonding part (arrow) cannot be differentiated from one another.

Bending strength test pieces having the size of 2 mm×1.5 mm×25 mm are prepared from the joined ceramics by using the same method as the first embodiment, and the 4-point bending strength is measured by using the same method as the first embodiment.

The 4-point bending strength test results are shown in Table 1, wherein comparison is made with the bending strength of the substrate. It can be seen that Joined ceramics No. 6, which corresponds to the sixth embodiment, has no external defects, and that the thickness of the bonding layer is formed to be equal to approximately 1.5 μm. For Joined ceramics No. 6, all test pieces are destroyed (or cracked) at inside the parent material, and the 4-point bending strength is equal to 464 MPa, which indicates that the bending strength is enhanced to approximately 61% as compared to the unique strength of the silicon carbide substrate.

### Embodiment 7

In order to create a bonding part having the same composition as the substrates, nothing is added to the bond, and, after aligning the two substrates in the form of sticks, the joined silicon carbide ceramics are processed with hot press heat treatment in a hot press heating device. At this point, the pressure of the hot press device is equal to 20 MPa, and the temperature of the heat treatment is 1850° C. The heat treatment is carried out for 1 hour, and argon gas is used for the heat-treatment atmosphere.

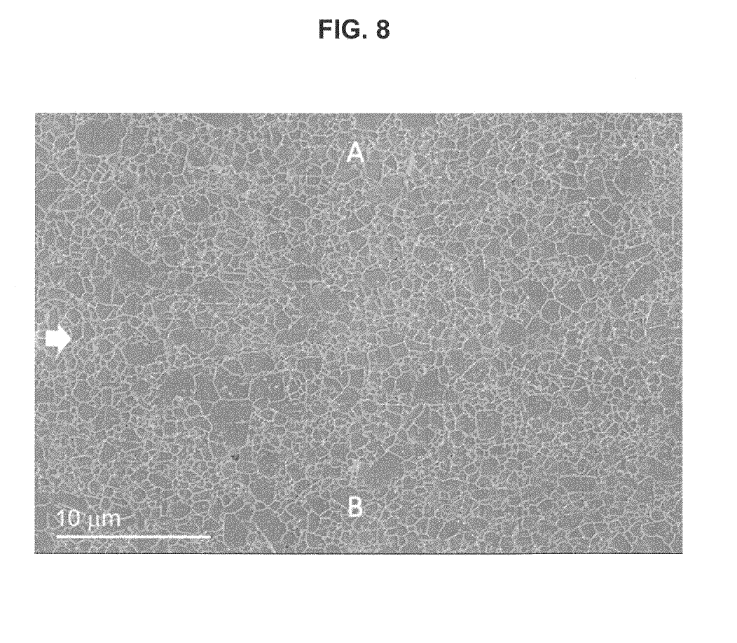

FIG. 8 is a microscopic photo taken by a scanning electron microscope of a cross-section of joined silicon carbide ceramics after being processed with the hot press heat treatment. It can be seen that the bonding result is good, since the two silicon carbide substrates (A, B) and the bonding part (arrow) cannot be differentiated from one another.

Bending strength test pieces having the size of 2 mm×1.5 mm×25 mm are prepared by using the same method as the first embodiment, and the 4-point bending strength is measured by using the same method as the first embodiment.

The 4-point bending strength test results are shown in Table 1, wherein comparison is made with the bending strength of the substrate. It can be seen that Joined ceramics No. 7, which corresponds to the seventh embodiment, has no external defects, and that the thickness of the bonding layer is formed to be equal to approximately 1˜2 μm. For Joined ceramics No. 7, all test pieces are destroyed (or cracked) at inside the parent material, and the 4-point bending strength is equal to 550 MPa, which indicates that the bending strength is enhanced to approximately 90% as compared to the strength of the silicon carbide substrate.

In case of the third to seventh embodiments, results show that the strength of the joined ceramics is more enhanced than the parent material, which is unusual. This is because when performing the bonding process, high temperature forging occurs during the hot press heat treatment process, thereby removing some of the remaining air holes in the substrates. And, due to a re-aligning of the silicon carbide particles, the strength of the joined ceramics has become greater than the strength of the substrates.

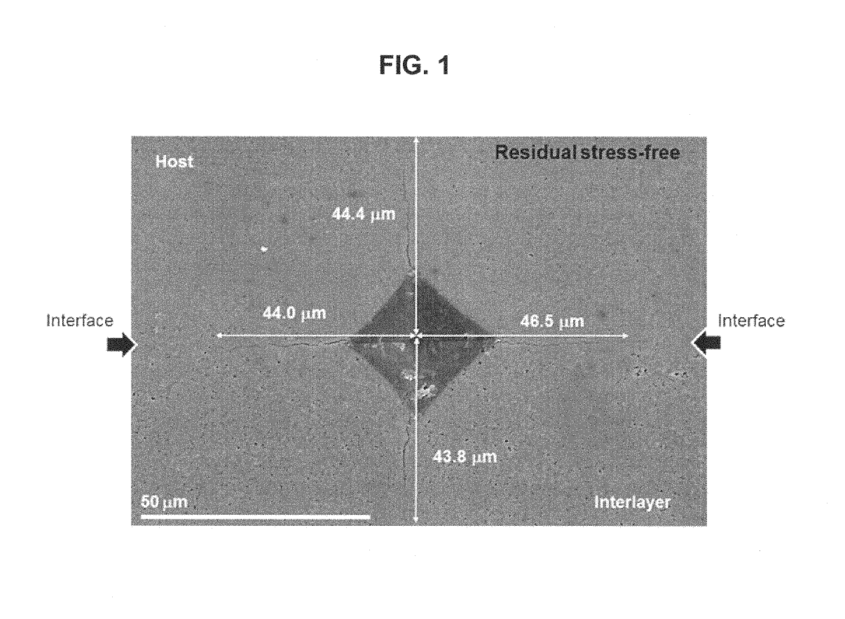

FIG. 1 relates to a case where a surface near the bonding surface is indented by using Vickers diamond particles by using a weight of 1 kgf in order to verify whether or not residual stress exists in the test piece, and where traces of the indention are observed through a scanning electron microscope. Herein, if residual stress exists, a difference in the length of cracks formed in 4 directions becomes clearly distinctive. However, in the joined ceramics of the present invention, the difference in the length of the cracks formed in the 4 directions is merely within an error range (within 5%). Accordingly, this proves that the residual stress does not exist.

As described above, the joined silicon carbide (SiC) ceramics and a method for processing the same according to the present invention may have the following advantages. According to the exemplary embodiment of the present invention, in the method for processing joined silicon carbide ceramics, by using a bond that has an identical composition as the silicon carbide substrate that is being joined (or bonded), the formation of cracks or residual stress, which may be generated due to a difference in the thermal expansion coefficient between the silicon carbide substrate and the joined ceramics, may be completely suppressed, thereby increasing the strength of the joined silicon carbide ceramics.

Additionally, while achieving the above-described advantageous effect, since the composition of the joined ceramics (or joint) is identical to the composition of the silicon carbide substrate, the joined ceramics may be operated as a single-type ceramic in an oxidation environment at a high temperature, thereby allowing stable joined ceramics to be processed and fabricating.

It will be apparent to those skilled in the art that various modifications and variations can be made in this specification without departing from the spirit or scope of this specification. Thus, it is intended that this specification covers the modifications and variations of this invention provided they come within the scope of the appended claims and their equivalents. It is also apparent that such variations of this specification are not to be understood individually or separately from the technical scope or spirit of this specification.

What is claimed is:

1. A method for processing joined silicon carbide (SiC) ceramics, comprising:
sintering silicon carbide substrates configuring the joined ceramics;
processing a joined silicon carbide ceramics preparation by layering a non-sintered silicon carbide bond having a same composition as the silicon carbide substrate between at least two substrates selected from the sintered silicon carbide substrates; and
processing the joined silicon carbide ceramics by performing heat treatment on the joined silicon carbide ceramics preparation.

2. The method of claim 1, wherein the silicon carbide bond corresponds to one of a silicon carbide sheet green body, silicon carbide powder, and silicon carbide slurry.

3. The method of claim 2, wherein the silicon carbide slurry is formed by being deposited or sprayed on a silicon carbide substrate.

4. The method of claim 1, wherein, in the step of processing a joined silicon carbide ceramics preparation, the joined silicon carbide ceramics preparation is processed with calcination in order to scatter organic matter remaining on the silicon carbide sheet.

5. The method of claim 4, wherein the calcination process is performed within a temperature range of 850˜900° C. during a time period of 30 minutes to 2 hours.

6. The method of claim 1, wherein, in the step of processing the joined silicon carbide ceramics, a processing atmosphere is identical to an atmosphere for the sintering of the silicon carbide substrate, and wherein the processing is performed at a temperature at which a sintering additive forms liquid.

7. The method of claim 6, wherein hot press is performed when performing sintering, the processing atmosphere corresponds to one of argon, nitrogen, or vacuum, and the heat treatment temperature ranges from 1750° C. to 2000° C.

8. The method of claim 1, wherein, in the step of sintering silicon carbide substrates, silicon carbide powder is mixed with a sintering additive, molded, and sintered at a temperature ranging from 1750° C. to 2100° C.

9. A method for processing joined silicon carbide (SiC) ceramics, comprising:
sintering silicon carbide substrates configuring the joined ceramics;
applying roughness to a surface of the silicon carbide substrate; and
contacting at least two silicon carbide substrates selected from the silicon carbide substrates having roughness applied thereto and bonding the at least two silicon carbide substrates with liquid at a liquid-forming temperature.

10. Joined silicon carbide (SiC) ceramics being processed by using claim 1, wherein residual stress does not exist throughout the entire joined ceramics, and wherein a strength of a bonding part corresponds to 65 to 190% of a strength of the substrate.
